(19) United States
(12) Patent Application Publication
(10) Pub. No.: US 2012/0278290 A1
(43) Pub. Date: Nov. 1, 2012

(54) DATABASE ARCHIVING MODEL ERROR DETECTION AND CORRECTION SYSTEM

(76) Inventors: Thomas Anthony Pinch, Sunnyvale, CA (US); Cedric Dandoy, Keller, TX (US)

(21) Appl. No.: 13/098,048

(22) Filed: Apr. 29, 2011

(51) Int. Cl. G06F 11/07; G06F 17/30

(52) U.S. Cl. 707/691; 707/690; 707/E17.005

(57) ABSTRACT

A database archiving model error detection and correction system including an error detection module to detect a referential integrity error in a database archiving model. A column in a foreign key and/or a corresponding unique key column to the foreign key column may include an assigned data mask operation. The error detection module may detect the referential integrity error if a corresponding other column in a foreign key-unique key relationship does not have an identical assigned data mask operation, or if the assigned data mask operation will not result in a unique output value for a unique input value.

### BACKGROUND

In a database archiving model representing business entities, tables may be provided and linked to each other by designated foreign key relationships. The archiving model may specify that data masking be performed on certain columns in the tables in the model. Data masking may include a process of protecting sensitive information in a database from inappropriate visibility. Masking may also be performed on columns that are part of the foreign key relationships used to build the archiving model. If the data were properly archived, the archived data would maintain the same foreign key relationship as the original data, even after data masking of a relevant foreign key column or its corresponding unique key column.

During the archiving process, if a column value is to be masked and that column is a constituent column in a foreign key-unique key relationship, then an error can result if the masking is performed improperly. The resulting archived data may include internal inconsistencies. The erroneously archived data can also lead to, for example, erroneous analysis and operations on the archived data.

### BRIEF DESCRIPTION OF DRAWINGS

The embodiments are described in detail in the following description with reference to the following figures.

FIG. 1 illustrates a database archiving model error detection and correction system, according to an embodiment;

FIG. 2 illustrates an example of a screen-shot for the database archiving model error detection and correction system, according to an embodiment;

FIG. 3 illustrates an example of a screen-shot for the database archiving model error detection and correction system, according to an embodiment;

FIG. 4 illustrates an example of a screen-shot for the database archiving model error detection and correction system, according to an embodiment;

FIG. 5 illustrates a method for database archiving model error detection and correction, according to an embodiment;

FIG. 6 illustrates examples of checks, proposed corrections and displays for a method for database archiving model error detection and correction, according to an embodiment; and

FIG. 7 illustrates a computer system that may be used for the method and system, according to an embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent that the embodiments may be practiced without limitation to all the specific details. Also, the embodiments may be used together in various combinations.

### 1. Overview

In a database archiving model, tables may be provided and linked to each other by designated foreign key relationships. Examples of foreign keys may include database foreign keys and virtual foreign keys. A database foreign key, when used in the context of relational databases, is a set of columns in one table (the referencing table) that refers to a corresponding set of columns in another table (the referenced table). For the foreign key, the specified columns in the referenced table will constitute a unique key. Further, for a row in the referencing table, the values in the specified columns will be found in the corresponding specified columns (i.e., the unique key columns) of a row in the referenced table. A virtual foreign key (i.e., a user-defined foreign key) may be built by a user by specifying columns in a table and associating those columns with unique key columns in a table. Thus even though the tables are not linked by a real foreign key from the standpoint of the database, they are nevertheless linked virtually. For a virtual foreign key (just as for a database foreign key), for a row in the referencing table, the values in the specified columns will be found in the corresponding specified columns of a row in the referenced table. Further, while a database foreign key will be associated with a database unique key, a virtual foreign key may be associated with either a database unique key or a virtual unique key. Examples of unique keys may include database unique keys, database primary keys, and virtual unique keys. A database unique key is a set of columns in a table whose values uniquely identify a row in that table (thus two different rows in the table may not have the same values in those columns). Examples of key combinations may include a database foreign key with referenced database unique key, a virtual foreign key with referenced database unique key, or a virtual foreign key with referenced virtual unique key. To build a virtual unique key, the user will specify columns in a table. For a virtual unique key (just as for a database unique key) the values in those columns will uniquely identify a row in the table (and thus two different rows in the table may not have the same values in those columns).

The archiving model may specify that data masking be performed on certain columns in the tables in the model, and on columns that are part of the foreign key relationships used to build the archiving model. A data mask may be a mechanism used to obscure sensitive data. In the context of a database, a column data mask operation may take as full or partial input the value in a column for a row in a database table, and return as output an acceptable obscured value. Depending on the type of mask operation, the column value may not be provided as input to the masking operation.

If the data is properly archived, the data would maintain the same foreign key relationship as the original data, even after data masking of a relevant foreign key column or its corresponding unique key column. During the archiving process, if a column value is to be masked and that column is a constituent column in a foreign key-unique key relationship, then a referential integrity error can result if the corresponding other column in the foreign key-unique key relationship does not have an identical mask operation assigned to it, or if the mask operation will not yield a unique output value for a unique input value. In other words, a referential integrity error can occur unless the corresponding other column in the foreign key-unique key relationship has an identical mask operation assigned to it, and the mask operation will yield a unique output value for a unique input value.

A database archiving model error detection and correction system allows a user to identify and correct erroneous data masking assignments that may otherwise lead to foreign key referential integrity errors. The foreign key referential integrity errors refer to errors in the values in the relevant columns of an incoming record (for example, a record that is being archived out to a table after having had masking done on it) intended for a table. The system provides for referential integrity checking for validating a user's selection of masks for foreign key columns and their referenced unique key columns. Depending on factors such as the complexity of a database archiving model, and the number of masks assigned to relevant foreign key columns and to their referenced unique key columns, a model may include several errors. The error detection and correction system described herein allows the user to iteratively ascertain errors, and with a radio button choice (where possible) as described below, cause a mask assignment that is assigned to a table column for one key to be also assigned as the mask for the corresponding table column for the other key in the foreign key-unique key relationship. Thus analysis and operations on archived data or otherwise linked data can be performed with an assurance that the archived data does not have any internal inconsistencies.

### 2. System

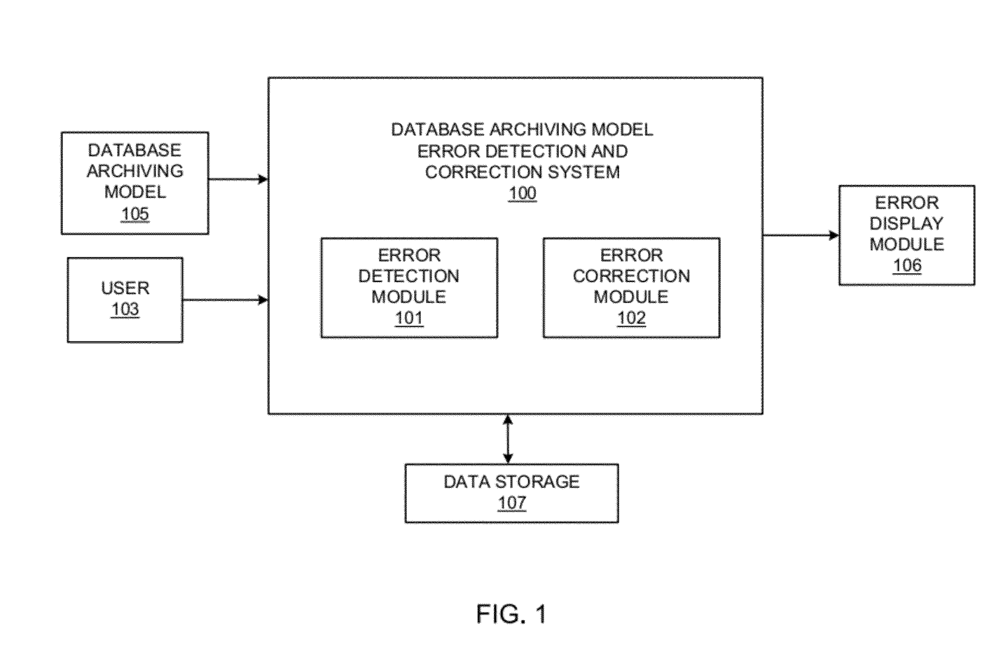

FIG. 1 illustrates a database archiving model error detection and correction system 100 (hereinafter “error detection and correction system”), according to an embodiment. The system 100 may include an error detection module 101 and an error correction module 102 for respectively detecting and allowing a user 103 to correct data masking errors in tables of a database archiving model 105 during construction of the model 105. The modules and other components of the system 100 may include machine readable instructions, hardware or a combination of machine readable instructions and hardware. While examples of application of the system 100 are described herein for tables in the database archiving model 105, the system 100 may be used with any type of data or file. The results of the error detection and correction may be displayed at an error display module 106 (i.e., a user interface (UI)), whereby a user may correct any data masking errors between the tables of the database archiving model 105 during construction of the model 105. A data storage 107 may be provided for storing information utilized by the system 100. The data storage 107 may include a database or other type of data management system.

Referring to FIGS. 1-4, examples of database masking, unique keys and foreign keys are provided for facilitating the description of the system 100.

A data mask may be a mechanism used to obscure data, for example, in a table. In the context of a database, a column data mask operation may use as full or partial input the value in a column for a row in a database table, and return as output an acceptable obscured value. Depending on the type of mask operation, the column value may not be provided as input to a masking operation. If data is being exported or archived from a source, such as a source file or source table to another destination such as an archive table or a destination file, when rows are copied over to the destination, any original data in a masked column may not be copied over to the corresponding column in the destination. Instead, the masked values may be written in the corresponding destination. Data masking may also include the use of data masking mapping tables or files. The archiving model 105 may include mapping tables that a user may use and also allows a user to define their own custom data masking mapping tables or files. Before a masking table can be used to perform masking during archive, a user may first populate the table with entries so that when archiving is performed, the table may be consulted to obtain a masked value for a given input value. An example of a data masking mapping table is described below.

Referring to Tables I and II, an example of a database masking operation is shown, whereby a constant value of XXX-XXX-XXXX is returned by the mask operation. As shown in Table I, an employee table is shown including employee IDs (EMPLOYEE_IDs), social security numbers (SSNs), hire dates (HIRE_DATEs), and manager employee IDs (MANAGER_EMP_IDs).

TABLE I
Employee Table

| EMP_ID | SSN | HIRE_DATE | MANAGER_EMP_ID |
|---|---|---|---|
| 1000 | 000-111-1111 | Dec. 01, 2010 | 1300 |
| 1300 | 000-222-2222 | Nov. 01, 2000 | 1200 |
| 1200 | 000-333-3333 | Feb. 11, 1999 | 1554 |
| 1050 | 000-444-4444 | May 01, 2003 | 0034 |

Table II shows the SSNs masked by replacing all SSNs with XXX-XXX-XXXX.

TABLE II
SSNs Masked

| EMP_ID | SSN | HIRE_DATE | MANAGER_EMP_ID |
|---|---|---|---|
| 1000 | XXX-XXX- | Dec. 01, 2010 | 1300 |
| | XXXX | | |
| 1300 | XXX-XXX- | Nov. 01, 2000 | 1200 |
| | XXXX | | |
| 1200 | XXX-XXX- | Feb. 11, 1999 | 1554 |
| | XXXX | | |
| 1050 | XXX-XXX- | May 01, 2003 | 0034 |
| | XXXX | | |

In a similar manner, the SSNs may be masked by, for example, replacing the first six digits with X's (not shown). Alternatively, as shown in Table III, the employee IDs may be skewed by adding, for example, 1000.

TABLE III
Employee IDs Skewed

| EMP_ID | SSN | HIRE_DATE | MANAGER_EMP_ID |
|---|---|---|---|
| 2000 | 000-111-1111 | Dec. 01, 2010 | 1300 |
| 2300 | 000-222-2222 | Nov. 01, 2000 | 1200 |
| 2200 | 000-333-3333 | Feb. 11, 1999 | 1554 |
| 2050 | 000-444-4444 | May 01, 2003 | 0034 |

Alternatively, the employee IDs from Table II may be masked by consulting a mapping table (see Table IV) for masked values (MASKED_IDs).

TABLE IV
Mapping Table

| EMPLOYEE_ID | MASKED_ID |
|---|---|
| 0034 | 7773333 |
| 1000 | 6761334 |
| 1050 | 2663434 |
| 1100 | 4332131 |
| 1200 | 3354451 |
| 1300 | 1253676 |
| 1400 | 9900876 |
| 1500 | 3353434 |
| 1554 | 7383246 |

Based on the looked-up masked values from Table IV, the resulting masked employee IDs are shown in Table V. Table IV shows a unique MASKED_ID value for each EMPLOYEE_ID value.

TABLE V
Employee IDs Masked

| EMP_ID | SSN | HIRE_DATE | MANAGER_EMP_ID |
|---|---|---|---|
| 6761334 | 000-111-1111 | Dec. 01, 2010 | 1300 |
| 1253676 | 000-222-2222 | Nov. 01, 2000 | 1200 |
| 3354451 | 000-333-3333 | Feb. 11, 1999 | 1554 |
| 2663434 | 000-444-4444 | May 01, 2003 | 0034 |

As described above, a unique key (when used in the context of relational databases) is a set of columns in a table whose values uniquely identify a row in that table. Thus, two different rows in a table may not have the same values in the columns.

Referring to Table VI, an example of a unique key is shown and includes a conference room table with a unique key built from column BUILDING_ID combined with CONFERENCE_ROOM_NUM. For example in the table below (if it is understood that two different buildings may not have the same ID and two different conference rooms in a building may not have the same number), a unique key could be specified as the BUILDING_ID column combined with the CONFERENCE_ROOM_NUM column.

TABLE VI
Unique Key Example

| | | CA- | |
|---|---|---|---|
| | | PAC- | PRO- |
| BUILDING_ID | CONFERENCE_ROOM_NUM | ITY | JECTOR |
| A | 100 | 20 | Yes |
| A | 200 | 10 | No |
| A | 201 | 35 | Yes |
| B | 100 | 30 | Yes |
| B | 200 | 10 | No |
| C | 100 | 45 | Yes |

For the unique key example of Table VI, while there is more than one row having a BUILDING_ID of “A” and more than one row with a CONFERENCE_ROOM_NUM of “200”, there is one row having the values “A” and “100” in the BUILDING_ID and CONFERENCE_ROOM_NUM columns respectively.

As described above, a foreign key, is a set of columns in one table (the referencing table) that refers to a corresponding set of columns in another table (the referenced table) for which the specified columns in the referenced table constitutes a unique key. Further, for a row in the referencing table, the values in the specified columns will be found in the corresponding specified columns (i.e., the unique key columns) of a row in the referenced table.

Referring to Table VII, an example of a foreign key is shown. The example includes a conference room scheduling table with a foreign key built from column BLDG_ID combined with column CONF_RM_NUMBER that corresponds to the unique key of the conference room Table VI.

TABLE VII
Foreign Key Example

| EMP_ID | BLDG_ID | CONF_RM_NUMBER |
|---|---|---|
| M10 | A | 100 |
| M10 | B | 100 |
| M10 | B | 200 |
| M20 | A | 100 |
| M20 | A | 200 |
| M20 | A | 201 |

As can be seen in Table VII, a foreign key may not need to be a unique key. For example, Table VII shows two rows that contain “A” in the BLDG_ID column along with “100” in the CONF_RM_NUMBER column. That is, both employees “M10” and “M20” may be responsible for scheduling conference room “100” in building “A”. Further, every row in the referenced table may not need to have a corresponding row in the referencing table. For example, for Table VII, this may implicitly be understood to mean that any employee may schedule conference room “100” in building “C”.

Referring to FIG. 1, the error detection module 101, the error correction module 102, and the error display module 106 that allows the user 103 to correct data masking errors between tables of the database archiving model 105 during construction thereof, are described.

In order to detect data masking referential integrity errors, module 101 may perform a referential integrity check or validation of all columns in each relevant foreign key definition on each table in the database archiving model. If one of the foreign key columns has a mask assigned to it, the corresponding table column for the associated unique key definition may be checked to ensure that it also has the same mask, and, if the mask is parameterized, that the two masks have identical parameters. Additionally, a check may be made to verify that the mask in question is reversible. The reversibility provides that a unique input will generate a unique output.

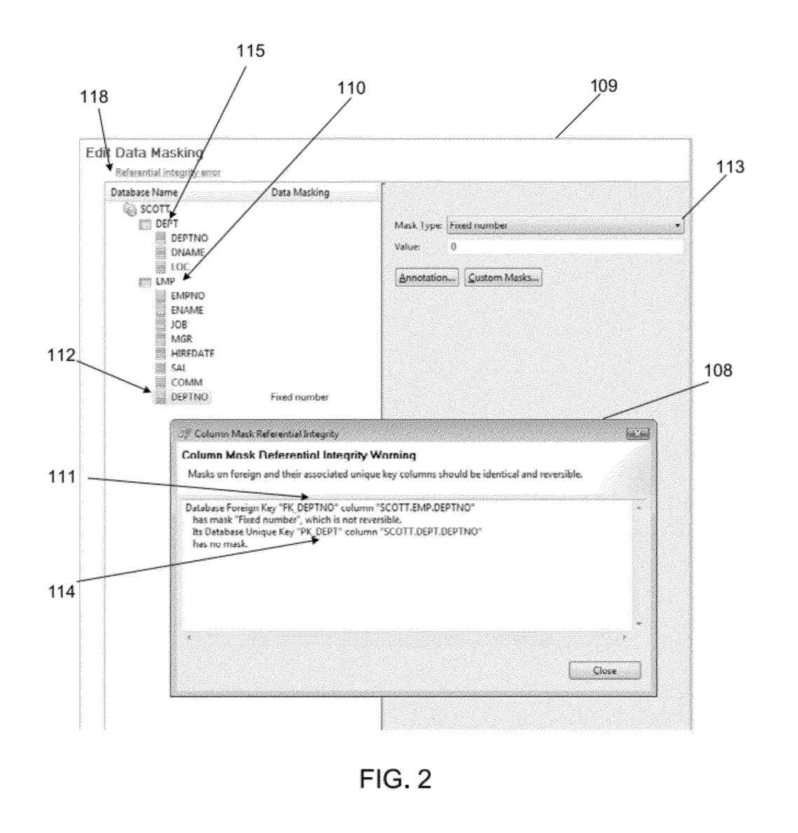

Module 101 may also perform the referential integrity validation whenever a relevant change is made to the database archiving model. For example, the validation may be performed when a new table is added to or removed from the database archiving model, or when the user 103 assigns a mask to a column or changes or deletes an existing mask. If a referential integrity error is found, an error status message link 118 (described below) may be displayed on the error display module 106, whereby the user 103 may correct the error via the error correction module 102. As illustrated in the examples described below with reference to FIGS. 2-4, clicking on the error status message link 118 may cause the display of an error warning/reconciliation dialog box 108 (see FIGS. 2-4) that details a validation failure. Examples of validation failure details may include:

i) Information related to the foreign key, its type (database or user-defined), and the foreign key table.

ii) The name of the relevant column in the foreign key table.

iii) Mask information, including parameters and reversibility, for the foreign key column (if a mask has been assigned).

iv) The name of the unique key corresponding to the foreign key, its type (database or user-defined), and the unique key table.

vi) The name of the column in the unique key corresponding to the foreign key column.

vii) Mask information, including parameters and reversibility, for the unique key column (if a mask has been assigned).

viii) Parameter discrepancies (if both columns have identical mask names but have different parameter values).

Based on the type of the validation error, the dialog box 108 may include a radio button 116 (see FIGS. 2 through 4). By selecting a radio button, the user 103 can either choose to assign the foreign key column mask (and any parameters) to the unique key column, or choose to assign the unique key column mask (and any parameters) to the foreign key column. The user 103 may review the information in the dialog box 108 and after accepting or rejecting any errors and proposed corrections, the database archiving model may be re-validated. If no further referential integrity validation errors are found by the module 101, the error status line may be removed. Otherwise, the error status line may remain displayed. In an example, the user 103 may click on the error status message link 118 to address any further referential integrity validation errors.

In order to detect and correct data masking referential integrity errors, examples of checks and proposed corrections performed by the error detection module 101 and the error correction module 102 are described. The following checks and proposed corrections are described in a simplified format and presented in pseudocode.

In the pseudocode below when checking is done to see whether there is a referential integrity error involving column masks, the pseudocode sometimes states that Error_Info is set to a value. This should be taken as shorthand indicating [i] that a field in the Error_Info object is set to that value and that [ii] additional relevant information will be set into other fields of Error_Info as well (including—as appropriate—types and names of keys, names of tables, names of masks, and mask parameter values). An example of pseudocode for detecting and correcting any referential integrity (ref integrity, for short) errors may include:

```
CHECK_MODEL_REF_INTEGRITY( ):
[1] Go through the tables in the model and get the Foreign Keys (FKs)
[2] For each Foreign Key in the list (FK):
  Get the referenced Unique Key (UK).
  If the table for the UK is also in the model:
    Check the FK and UK to see if there is a ref integrity error
[CHECK_FK_UK_REF_INTEGRITY( )]
  If there is a ref integrity error, stop looking for other ref integrity errors.
[3] If a ref integrity error was found, show the error link in the UI; else
remove the link.
```

The pseudocode for Display/Resolve ref integrity error [DISPLAY_RESOLVE_REF_INTEGRITY_ERROR( )] described below discusses the options available to the user 103 when the error link in the error display module 106 (e.g. UI) is clicked. An example of pseudocode for checking the foreign key (FK) and unique key (UK) for a referential integrity error may include:

```
CHECK_FK_UK_REF_INTEGRITY( ):
[1] Get the list of columns that make up the FK (FK_Columns)
[2] Get the list of columns that make up the UK (UK_Columns)
[3] For each pair of corresponding columns in FK_Column UK_Column
(FK_Col and UK_Col):
  Check if there is a ref integrity error between FK_Col and UK_Col
[CHECK_FK_COL_UK_COL_REF_INTEGRITY( )]
  If there is a ref integrity error, stop looking for other errors for other
column pairs.
[4] If a ref integrity error was found, return that information to the calling
function, else return no error.
```

An example of pseudocode for checking if there is a referential integrity error between FK_Col and UK_Col may include:

CHECK_FK_COL_UK_COL_REF_INTEGRITY( ):
[1] Get any mask assigned to FK_Col (FK_Col_Mask).
[2] Get any mask assigned to UK_Col (UK_Col_Mask).
[3] Check if there is a 1-to-1 error with masks on the columns
[CHECK_FK_COL_UK_COL_MASK_ONE_TO_ONE( )]
[4] If there is a 1-to-1 error, note it and return that information to the
calling function.
[5] Check if there is some other ref integrity error
[CHECK_FK_COL_UK_COL_MASK_OTHER( )]
[6] If there is some other ref integrity error, note it and return that
information to the calling function, else return that there is no error.

An example of pseudocode for checking if there is a 1-to-1 error with masks on the columns may include:

```
CHECK_FK_COL_UK_COL_MASK_ONE_TO_ONE( ):
[1] Error_Info will be set to contain error information about a error.
[2] Check for errors:
  If FK_Col_Mask exists
    If UK_Col_Mask exists
      If FK_Col_Mask is 1-to-1
        If UK_Col_Mask is 1-to-1
          Both masks are 1-to-1 and there is no 1-to-1 error: so set
Error_Info to NULL
        Else
          FK_Col_Mask is 1-to-1, but UK_Col_Mask is not 1-to-1:
so set Error_Info to FK_ONE_TO_ONE_UK_NOT_ONE_TO_ONE
    Else
      If UK_Col_Mask is 1-to-1
        FK_Col_Mask is not 1-to-1 but UK_Col_Mask is 1-to-1: so
set Error_Info to FK_NOT_ONE_TO_ONE_UK_ONE_TO_ONE
      Else
        Neither FK_Col_Mask nor UK_Col_Mask are
1-to-1: so set Error_Info to
FK_NOT_ONE_TO_ONE_UK_NOT_ONE_TO_ONE
  Else
    If FK_Col_Mask is 1-to-1
      FK_Col_Mask is 1-to-1, but UK_Col_Mask doesn't exist: so set
Error_Info to FK_ONE_TO_ONE_NO_UK_MASK
    Else
      FK_Col_Mask is not 1-to-1 and UK_Col_Mask doesn't exist: so
set Error_Info to FK_NOT_ONE_TO_ONE_NO_UK_MASK
  Else if UK_Col_Mask exists
    If UK_Col_Mask is 1-to-1
      FK_Col_Mask doesn't exist, but UK_Col_Mask is 1-to-1: so set
Error_Info to NO_FK_MASK_UK_ONE_TO_ONE
    Else
      FK_Col_Mask doesn't exist, and UK_Col_Mask is not 1-to-1:
so set Error_Info to NO_FK_MASK_UK_NOT_ONE_TO_ONE
  Else
    FK_Col_Mask doesn't exist and UK_Col_Mask doesn't exist,
so there is no 1-to-1 error: so set Error_Info to NULL
[3] Return the Error_Info information to the calling function.
```

An example of pseudocode for checking if there is some other referential integrity error may include:

```
CHECK_FK_COL_UK_COL_MASK_OTHER( ):
[1] Error_Info will be set to contain error information about a error.
[2] Check for errors:
  If FK_Col_Mask exists
    If UK_Col_Mask exists
      If FK_Col_Mask and UK_Col_Mask are not the same (or if any
parameters that they have are not the same)
        If FK_Col_Mask and UK_Col_Mask are the same
          Masks are same, but the parameters mismatch: set
Error_Info to
VALUES_MISMATCH_FK_ONE_TO_ONE_UK_ONE_TO_ONE
        Else
          The masks are not the same: so set Error_Info to
NAME_MISMATCH_FK_ONE_TO_ONE_UK_ONE_TO_ONE
      Else
        The masks and their parameters are the same: so set
Error_Info to NULL
    Else
      FK_Col_Mask exists, but UK_Col_Mask does not exist: so set
Error_Info to NO_UK_MASK
  Else
    If UK_Col_Mask exists
      UK_Col_Mask exists, but FK_Col_Mask does not exist: so set
Error_Info to NO_FK_MASK
    Else
      FK_Col_Mask does not exist and UK_Col_Mask does not exist,
so there is no 1-to-1 error: so set Error_Info to NULL
[3] Return the Error_Info information to the calling function.
```

An example of pseudocode for displaying and correcting (i.e., resolving) a referential integrity error may include:

```
DISPLAY_RESOLVE_REF_INTEGRITY_ERROR( ):
[1] If the user clicks on the error link
  Populate a dialog with the relevant information from the Error_Info for
the noted ref integrity error
  If there is an error that the user can be guided to fix
  Include the relevant radio buttons (one or both of the two below) in the
dialog:
      Button that indicates that the mask on the unique key column
should be assigned to the foreign key column
      Button that indicates that the mask on the foreign key column
should be assigned to the unique key column
    Include OK and Cancel buttons on the dialog
    The OK button is enabled when a radio button is selected
  Else
    Include just a Close button on the dialog
  If the user exits the dialog with an OK button press
    Set the appropriate mask on the appropriate column as per the radio
button selection.
    Update the UI to show the new mask assignment against the relevant
column.
    Check to see if there are any ref integrity errors in the model
[CHECK_MODEL_REF_INTEGRITY( )]
```

The error displayed at error display module 106 may include whether a key is a database key or a virtual key. The error displayed may also indicate whether a mask is actually reversible or (in the case of data masking mapping table or files) just presumed reversible.

Examples of simplified error types and related descriptions are as follows:

i) FK_NOT_ONE_TO_ONE_UK_ONE_TO_ONE means foreign key (FK) column FK_COL has mask FK_MASK, which is not reversible. Its unique key (UK) column UK_COL has mask UK_MASK, which is reversible.

ii) FK_NOT_ONE_TO_ONE_NO_UK_MASK means foreign key (FK) column FK_COL has mask FK_MASK, which is not reversible. Its unique key (UK) column UK_COL has no mask.

iii) FK_ONE_TO_ONE_UK_NOT_ONE_TO_ONE means foreign key (FK) column FK_COL has mask FK_MASK, which is reversible but its unique key (UK) column UK_COL has mask UK_MASK, which is not reversible.

iv) FK_ONE_TO_ONE_NO_UK_MASK means foreign key (FK) column FK_COL has mask FK_MASK, which is reversible but its unique key (UK) column UK_COL has no mask.

v) NO_FK_MASK_UK_NOT_ONE_TO_ONE means foreign key (FK) column FK_COL has no mask. Its unique key (UK) column UK_COL has mask UK_MASK, which is not reversible.

vi) NO_FK_MASK_UK_ONE_TO_ONE means foreign key (FK) column FK_COL has no mask. Its unique key (UK) column UK_COL has mask UK_MASK, which is reversible.

vii) FK_NOT_ONE_TO_ONE_UK_NOT_ONE_TO_ONE means foreign key (FK) column FK_COL has mask FK_MASK, which is not reversible. Its unique key (UK) column UK_COL has mask UK_MASK, which is also not reversible.

viii) NAME_MISMATCH_FK_ONE_TO_ONE_UK_ONE_TO_ONE means foreign key (FK) column FK_COL has reversible mask FK_MASK, but its unique key (UK) column UK_COL has reversible mask UK_MASK.

ix) VALUES_MISMATCH_FK_ONE_TO_ONE_UK_ONE_TO_ONE means foreign key (FK) column FK_COL and its unique key (UK) column UK_COL both have mask “MASK”, which is SOME_MASK but the values do not match:

FK column mask values:

FK_COL_MASK_VALUE1, FK_COL_MASK_VALUE2, . . . .

UK column mask values:

UK_COL_MASK_VALUE1, UK_COL_MASK_VALUE2, . . . .

x) NO_UK_MASK means foreign key (FK) column FK_COL has mask FK_MASK but its unique key (UK) column UK_COL has no mask set.

xi) NO_FK_MASK means foreign key (FK) column FK_COL has no mask set, but its unique key (UK) column UK_COL has mask UK_MASK.

For the foregoing, FK, FK_COL, FK_MASK, UK, UK_COL, UK_MASK, MASK, SOME_MASK, FK_COL_MASK_VALUE1, FK_COL_MASK_VALUE2, UK_COL_MASK_VALUE1, UK_COL_MASK_VALUE2 may be designated placeholders.

Examples of referential integrity validation by error detection module 101 and error correction module 102 are now described with reference to FIGS. 1-4, whereby the user 103 may correct any errors displayed on the error display module 106.

Referring to FIG. 2, a screen-shot 109 of a database archiving model may include a table SCOTT.EMP 110 including a foreign key FK_DEPTNO 111 defined on it. The column DEPTNO 112 may be a column of the foreign key 111 and may be assigned a non-reversible mask named “Fixed number” at 113. The unique key associated with the foreign key may be PK_DEPT 114 and may be defined on the table SCOTT.DEPT 115. The foreign key-unique key mapping may identify DEPTNO on SCOTT.EMP as the column which corresponds to the DEPTNO column on SCOTT.DEPT. In this case, the DEPTNO column on the table SCOTT.DEPT has no mask assigned to it.

When a referential integrity validation is performed by error detection module 101, two errors result. First, one of the columns has a mask assigned to it but the other one does not. Secondly, the mask that has been assigned is a non-reversible mask. Because the unique key column mask is not reversible, error display module 106 does not provide a radio button allowing the user to also assign it as the mask for the corresponding foreign key column.

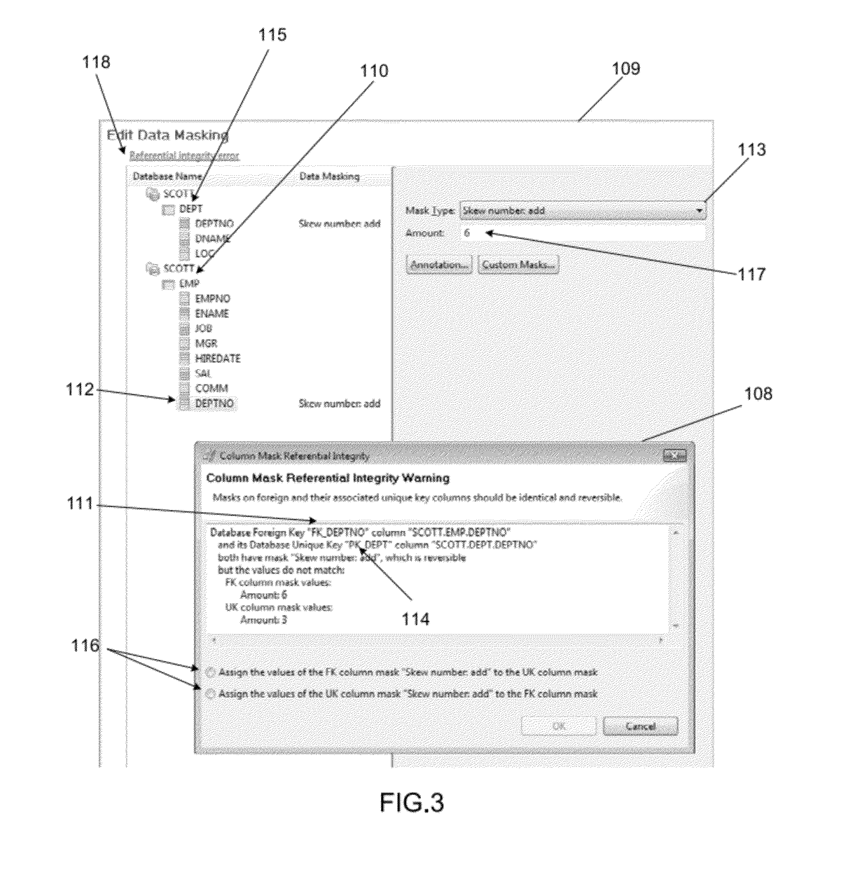

Referring to FIG. 3, in another example, the screen-shot 109 of a database archiving model may include the table SCOTT.EMP 110 including the foreign key FK_DEPTNO 111 defined on it. The column DEPTNO 112 may be part of the foreign key 111 and is assigned a reversible mask named “Skew number: add” at 113, which takes an amount parameter that has been set to the value “6” at 117. The unique key associated with the foreign key may be PK_DEPT 114 and is defined on the table SCOTT.DEPT 115. The foreign key-unique key mapping may identify DEPTNO on SCOTT.EMP as the column which corresponds to the DEPTNO column on SCOTT.DEPT. As shown in FIG. 3, the DEPTNO column on SCOTT.DEPT also has been assigned the mask “Skew number: add”, but in this case the amount parameter is set to the value “3”.

When a referential integrity validation is performed by error detection module 101, an error results. Although both the columns have the same mask and the mask is reversible, the amount parameter has not been set to the same value. Since the failure is due to the difference in the amount parameter, two radio buttons 116 may be provided so that the user 103 may choose to force the amount parameter on the mask for the column on either key to be copied over to become the amount parameter for the mask on the other.

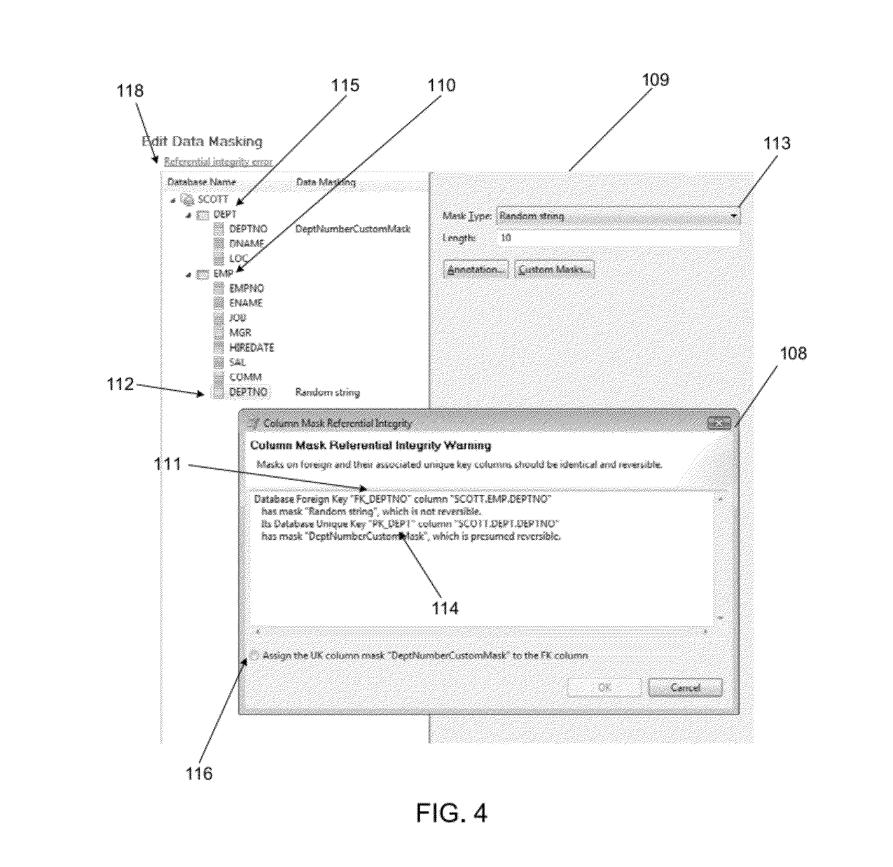

Referring to FIG. 4, the screen-shot 109 of a database archiving model may include the table SCOTT.EMP 110 including the foreign key FK_DEPTNO 111 defined on it. The column DEPTNO 112 may be a column of the foreign key 111 and may be assigned the non-reversible mask named “Random string” at 113. The unique key associated with the foreign key may be PK_DEPT 114 and may be defined on the table SCOTT.DEPT 115. The foreign key-unique key mapping may identify DEPTNO on SCOTT.EMP as the column which corresponds to the DEPTNO column on SCOTT.DEPT. As shown in FIG. 4, the DEPTNO column on SCOTT.EMP may have custom mask DeptNumberCustomMask assigned to it.

When a referential integrity validation is performed by error detection module 101, an error results. The foreign key column DEPTNO on SCOTT.EMP may have a (presumed) reversible mask assigned to it but its counterpart unique key column DEPTNO on SCOTT.EMP has a non-reversible mask assigned to it. Since the unique key column has a reversible mask on it, the radio button 116 may be provided. The user 103 may select the radio button to force the unique key column's mask to also be assigned as the mask for the corresponding column in the foreign key.

Referring to Tables VIII to XV, examples of valid and erroneous masking performed on tables in the database archiving model 105 are described.

Table VIII is a Conference Room table with a unique key including column CONF_RM as follows:

TABLE VIII
Conference Room

| CONF_RM | CAPACITY | PROJ |
|---|---|---|
| 100 | 20 | Yes |
| 200 | 10 | No |
| 201 | 35 | Yes |

Table IX is a Conference Room Scheduling table that has a foreign key including column CONF_RM_NUM. The referenced unique key is the unique key in the Table VIII (Conference Room table).

TABLE IX
Conference
Room Scheduling

| EMP_ID | CONF_RM_NUM |
|---|---|
| M10 | 100 |
| M10 | 200 |
| M20 | 201 |

Assuming that Tables VIII and IX are to be archived and that at that time a mask that skews by adding 400 will be applied to the CONF_RM column values from the Conference Room table and to CONF_RM_NUM column values from the Conference Room Scheduling table, when the archive is performed, the archived Tables X and XI are as follows:

TABLE X
Conference Room

| CONF_RM | CAPACITY | PROJ |
|---|---|---|
| 500 | 20 | Yes |
| 600 | 10 | No |
| 601 | 35 | Yes |

TABLE XI
Conference
Room Scheduling

| EMP_ID | CONF_RM_NUM |
|---|---|
| M10 | 500 |
| M10 | 600 |
| M20 | 601 |

It can be seen that in the archived Tables X and XI, the entries are properly linked. This is because the same mask has been applied to both columns and the mask has the property that for a unique input value a unique output value is returned. As a consequence, in the Conference Room Scheduling table, a user can look up the number of any conference room that employee M10 administers, for example, room 500, and then the user can look at the Conference Room table and see what the characteristics of that conference room are: room 500 can accommodate 20 people and has a projector.

If two different masks had been applied to the relevant column values from the two source Tables VIII and IX during the archive, then the data in the archived Tables X and XI would likely not have been properly linked. For example, if the CONF_RM column values of the Conference Room table are masked by a mask that skews by adding 400 but the CONF_RM_NUM column values of the Conference Room Scheduling table are masked by a mask that skews by adding 200, then the following archive Tables XII and XIII result:

TABLE XII
Conference Room

| CONF_RM | CAPACITY | PROJ |
|---|---|---|
| 500 | 20 | Yes |
| 600 | 10 | No |
| 601 | 35 | Yes |

TABLE XIII
Conference
Room Scheduling

| EMP_ID | CONF_RM_NUM |
|---|---|
| M10 | 300 |
| M10 | 400 |
| M20 | 401 |

In this case the user may be unable to determine the characteristics of the individual conference rooms that are administered by the employees in the archived version of the Conference Room Scheduling table. This is because even though the two masks chosen both have the property that for a unique input value a unique output value is returned, since the masks are different, the generated conference room number values do not match up.

Similar errors may also result due to improper linking between the archived table entries for some other masking choices. For example, if the values from the conference room column in one source table were masked but the values from the conference room column in the other source table were not masked, or if the same mask was chosen to mask the values from the two conference room columns in the two source tables but that mask was not one that gave a unique output for a unique input. An example of the latter would be a mask that replaces all values by XXX. In this case with values taken from Tables VIII and IX, the resulting archive Tables XIV and XV will have results as follows:

TABLE XIV
Conference Room

| CONF_RM | CAPACITY | PROJ |
|---|---|---|
| XXX | 20 | Yes |
| XXX | 10 | No |
| XXX | 35 | Yes |

TABLE XV
Conference
Room Scheduling

| EMP_ID | CONF_RM_NUM |
|---|---|
| M10 | XXX |
| M10 | XXX |
| M20 | XXX |

In this case, a user may be unable to determine what the characteristics are of a given conference room that is administered by an employee in the archived version of the Conference Room Scheduling table.

Thus the system 100 may analyze the database archiving model 105 to look at mask choices on columns and check whether those columns are part of foreign key-unique key relationships and determine whether those mask choices will result in an error downstream when archiving actually occurs. If an error is identified, the user can, where possible, use modules 102 and 106 to assign a correct matching mask.

Further, the referential integrity checking done by the system 100 does not evaluate keys which do not link tables in the database archiving model 105. For example, if only the Conference Room table shown in Table VIII is to be archived and the values of the CONF_RM column will be masked (by any kind of mask) then no checking may be performed. This is because the checking performed by the system 100 may check to see that that linkages between foreign keys and their unique keys would be maintained, and in the examples of Tables VIII to XV, there is no table in the database archiving model 105 that has an foreign key with a column that points back to the CONF_RM column in the Conference Room table.

In another example, if the Conference Room Scheduling table shown in Table IX is to be archived and the value of the CONF_RM_NUM column will be masked (by any kind of mask), in this case, no checking will be performed. This is because the checking that is done by the ref integrity checking mechanism only looks to see that that linkages between foreign keys and their unique keys would be maintained, and in this case, there is no table in the database archiving model 105 that the CONF_RM_NUM column in the Conference Room table points at.

### 3. Method

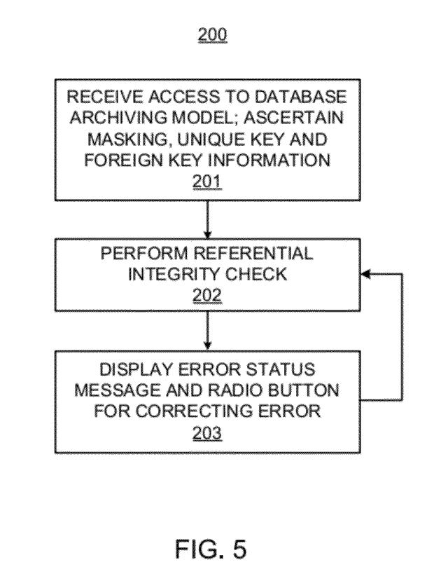

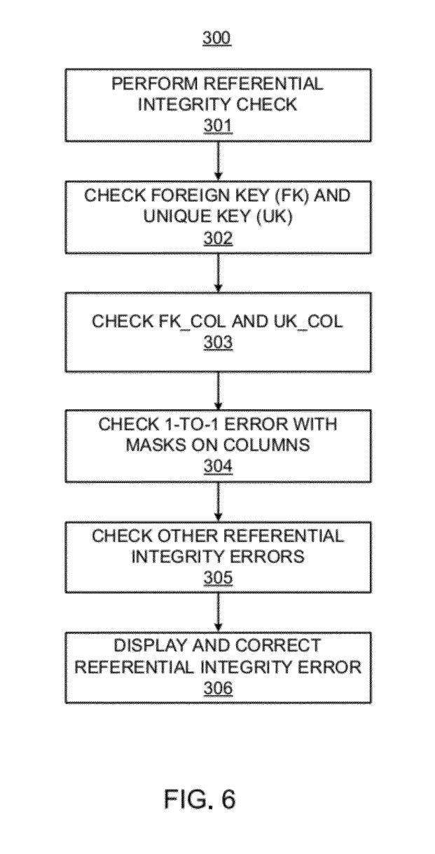

FIG. 5 illustrates a method 200 for database archiving model error detection and correction, according to an embodiment. FIG. 6 illustrates examples of checks, proposed corrections and displays for a method 300 for database archiving model error detection and correction, according to an embodiment. The methods 200 and 300 are described with respect to the database archiving model error detection and correction system 100 shown in FIGS. 1-4 by way of example and not limitation. The methods 200 and 300 may be performed by other systems.

At block 201, the system 100 may receive access to the database archiving model 105, and information related to masking, unique keys and foreign keys in the tables of the database archiving model. Thus the system 100 may ascertain names of columns in the tables of the database archiving model 105, which constitute foreign keys and their unique keys, and the characteristics of the masks that may be assigned to these columns.

At block 202, the module 101 may perform a referential integrity check or validation of all columns in each relevant foreign key definition on each table in the database archiving model. If one of the foreign key columns has a mask assigned to it, the corresponding table column for the associated unique key definition may be checked to ensure that it also has the same mask, and, if the mask is parameterized, that the two masks have identical parameters. Additionally, a check may be made to verify that the mask in question is reversible. The reversibility provides that a unique input will generate a unique output. The module 101 may also perform the referential integrity validation whenever a relevant change is made to the database archiving model. For example, the validation may be performed when a new table is added to or removed from the database archiving model, or when the user 103 assigns a mask to a column or changes or deletes an existing mask.

At block 203, if a referential integrity error is found, the error status message link 118 may be displayed on the error display module 106, whereby the user 103 may correct the error via the error correction module 102. If a referential integrity error is not found, the error display module 106 may indicate accordingly. As illustrated in the examples described above with reference to FIGS. 2-4, clicking on the error link may cause the display of the dialog box 108 (see FIGS. 2-4) that details a validation failure. As also described above, examples of validation failure details may include:

i) Information related to the foreign key, its type (database or user-defined), and the foreign key table.

ii) The name of the relevant column in the foreign key table.

iii) Mask information, including parameters and reversibility, for the foreign key column (if a mask has been assigned).

iv) The name of the unique key corresponding to the foreign key, its type (database or user-defined), and the unique key table.

vi) The name of the column in the unique key corresponding to the foreign key column.

vii) Mask information, including parameters and reversibility, for the unique key column (if a mask has been assigned).

viii) Parameter discrepancies (if both columns have identical mask names but have different parameter values).

Further, at block 203, the error warning/reconciliation dialog box 108 may be displayed. The radio buttons 116 may also be displayed as discussed above. Once a user presses, for example, “OK” to exit the dialog, the system 100 may determine whether any other errors exist and the error status message link 118 may be left in place or cleared accordingly. Thus the control effectively goes to block 202. Based on the nature of the validation error, the dialog box 108 may include the radio button 116 that allows the user 103 to either choose to assign the foreign key column mask (and any parameters) to the unique key column, or choose to assign the unique key column mask (and any parameters) to the foreign key column. The user 103 may review the information in the dialog box 108 and after accepting or rejecting any errors and proposed corrections, the database archiving model may be re-validated. If no further referential integrity validation errors are found by the module 101, the error status message link 118 may be removed. Otherwise, the error status message link 118 may remain displayed.

The details of block 300, whereby checks, proposed corrections and displays may be made during performance of the referential integrity check at block 202 and the error status message link 118 may be displayed at block 203 are described below with reference to FIG. 6.

Referring to FIG. 6, at block 301, a referential integrity (e.g. ref integrity) error may be detected and corrected by the modules 101, 102, respectively, as follows (example of pseudocode shown):

```
CHECK_MODEL_REF_INTEGRITY( ):
[1] Go through the tables in the model and get the Foreign Keys (FKs)
[2] For each Foreign Key in the list (FK):
  Get the referenced Unique Key (UK).
  If the table for the UK is also in the model:
    Check the FK and UK to see if there is a ref integrity error
[CHECK_FK_UK_REF_INTEGRITY( )]
  If there is a ref integrity error, stop looking for other ref integrity errors.
[3] If a ref integrity error was found show the error link in the UI, else
remove the link.
```

At block 302, a referential integrity error may be detected by the module 101 as follows (example of pseudocode shown for checking the foreign key (FK) and unique key (UK)):

```
CHECK_FK_UK_REF_INTEGRITY( ):
[1] Get the list of columns that make up the FK (FK_Columns)
[2] Get the list of columns that make up the UK (UK_Columns)
[3] For each pair of corresponding columns in FK_Column UK_Column
(FK_Col and UK_Col):
  Check if there is a ref integrity error between FK_Col and UK_Col
[CHECK_FK_COL_UK_COL_REF_INTEGRITY( )]
  If there is a ref integrity error, stop looking for other errors for other
column pairs.
[4] If a ref integrity error was found, return that information to the calling
function, else return no error.
```

At block 303, a referential integrity error between FK_Col and UK_Col may be detected by the module 101 as follows (example of pseudocode shown):

CHECK_FK_COL_UK_COL_REF_INTEGRITY( ):
[1] Get any mask assigned to FK_Col (FK_Col_Mask).
[2] Get any mask assigned to UK_Col (UK_Col_Mask).
[3] Check if there is a 1-to-1 error with masks on the columns
[CHECK_FK_COL_UK_COL_MASK_ONE_TO_ONE( )]
[4] If there is a 1-to-1 error, note it and return that information to the
calling function.
[5] Check if there is some other ref integrity error
[CHECK_FK_COL_UK_COL_MASK_OTHER( )]
[6] If there is some other ref integrity error, note it and return that
information to the calling function, else return that there is no error.

At block 304, a 1-to-1 error with masks on the columns may be detected by the module 101 as follows (example of pseudocode shown):

```
CHECK_FK_COL_UK_COL_MASK_ONE_TO_ONE( ):
[1] Error_Info will be set to contain error information about a error.
[2] Check for errors:
  If FK_Col_Mask exists
    If UK_Col_Mask exists
      If FK_Col_Mask is 1-to-1
        If UK_Col_Mask is 1-to-1
          Both masks are 1-to-1 and there is no 1-to-1 error: so
set Error_Info to NULL
        Else
          FK_Col_Mask is 1-to-1, but UK_Col_Mask
is not 1-to-1: so set Error_Info to
FK_ONE_TO_ONE_UK_NOT_ONE_TO_ONE
    Else
      If UK_Col_Mask is 1-to-1
        FK_Col_Mask is not 1-to-1 but UK_Col_Mask is
1-to-1: so set Error_Info to
FK_NOT_ONE_TO_ONE_UK_ONE_TO_ONE
      Else
        Neither FK_Col_Mask nor UK_Col_Mask are 1-to-1:
so set Error_Info to
FK_NOT_ONE_TO_ONE_UK_NOT_ONE_TO_ONE
  Else
    If FK_Col_Mask is 1-to-1
      FK_Col_Mask is 1-to-1, but UK_Col_Mask doesn't exist: so set
Error_Info to FK_ONE_TO_ONE_NO_UK_MASK
    Else
      FK_Col_Mask is not 1-to-1 and UK_Col_Mask doesn't exist: so
set Error_Info to FK_NOT_ONE_TO_ONE_NO_UK_MASK
  Else if UK_Col_Mask exists
    If UK_Col_Mask is 1-to-1
      FK_Col_Mask doesn't exist, but UK_Col_Mask is 1-to-1: so set
Error Info to NO_FK_MASK_UK_ONE_TO_ONE
    Else
      FK_Col_Mask doesn't exist, and UK_Col_Mask is not 1-to-1:
so set Error_Info to NO_FK_MASK_UK_NOT_ONE_TO_ONE
  Else
    FK_Col_Mask doesn't exist and UK_Col_Mask doesn't exist,
so there is no 1-to-1 error: so set Error_Info to NULL
[3] Return the Error_Info information to the calling function
```

At block 305, other referential integrity errors may be detected by the module 101 as follows (example of pseudocode shown):

```
CHECK_FK_COL_UK_COL_MASK_OTHER( ):
[1] Error_Info will be set to contain error information about a error.
[2] Check for errors:
  If FK_Col_Mask exists
    If UK_Col_Mask exists
      If FK_Col_Mask and UK_Col_Mask are not the same (or if any
parameters that they have are not the same)
        If FK_Col_Mask and UK_Col_Mask are the same
          Masks are same, but the parameters
mismatch: set Error_Info to
VALUES_MISMATCH_FK_ONE_TO_ONE_UK_ONE_TO_ONE
        Else
          The masks are not the same: so set Error_Info to
NAME_MISMATCH_FK_ONE_TO_ONE_UK_ONE_TO_ONE
      Else
        The masks and their parameters are the same: so set
Error_Info to NULL
  Else
      FK_Col_Mask exists, but UK_Col_Mask does not exist: so set
Error_Info to NO_UK_MASK
  Else
    If UK_Col_Mask exists
      UK_Col_Mask exists, but FK_Col_Mask does not exist: so set
Error_Info to NO_FK_MASK
    Else
      FK_Col_Mask does not exist and UK_Col_Mask does not exist,
so there is no 1-to-1 error: so set Error_Info to NULL
[3] Return the Error_Info information to the calling function.
```

At block 306, details of a referential integrity error may be displayed and the error possibly corrected by the error display module 106 and the error correction module 102, respectively, as follows (example of pseudocode shown):

```
DISPLAY_RESOLVE_REF_INTEGRITY_ERROR( ):
[1] If the user clicks on the error link
  Populate a dialog with the relevant information from the Error_Info for
the noted ref integrity error
  If there is an error that the user can be guided to fix
    Include the relevant radio buttons (one or both of the two below) in
the dialog:
      Button that indicates that the mask on the unique key column
should be assigned to the foreign key column
      Button that indicates that the mask on the foreign key column
should be assigned to the unique key column
    Include OK and Cancel buttons on the dialog
    The OK button is enabled when a radio button is selected
  Else
    Include just a Close button on the dialog
  If the user exits the dialog with an OK button press
    Set the appropriate mask on the appropriate column as per the radio
button selection.
    Update the UI to show the new mask assignment against the relevant
column.
      Check to see if there are any ref integrity errors in the model
[CHECK_MODEL_REF_INTEGRITY( )]
```

### 4. Computer Readable Medium

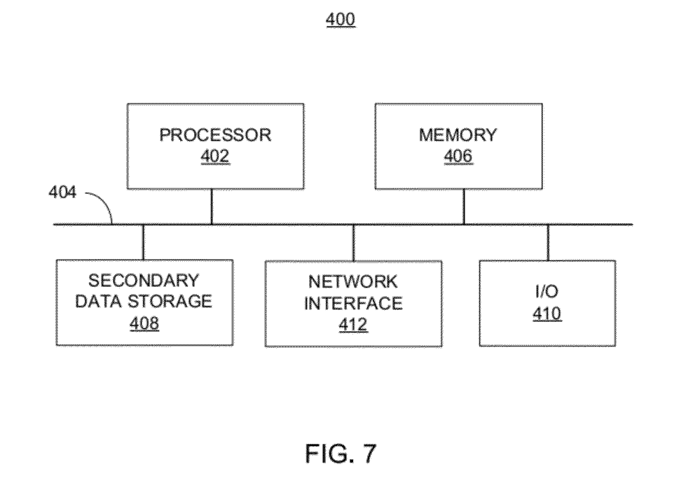

FIG. 7 shows a computer system 400 that may be used with the embodiments described herein. The computer system 400 represents a generic platform that includes components that may be in a server or another computer system. The computer system 400 may be used as a platform for the system 100. The computer system 400 may execute, by a processor or other hardware processing circuit, the methods, functions and other processes described herein. These methods, functions and other processes may be embodied as machine readable instructions stored on computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 400 includes a processor 402 that may implement or execute machine readable instructions performing some or all of the methods, functions and other processes described herein. Commands and data from the processor 402 are communicated over a communication bus 404. The computer system 400 also includes a main memory 406, such as a random access memory (RAM), where the machine readable instructions and data for the processor 402 may reside during runtime, and a secondary data storage 408, which may be non-volatile and stores machine readable instructions and data. The memory and data storage are examples of computer readable mediums.

The computer system 400 may include an I/O device 410, such as a keyboard, a mouse, a display, etc. The computer system 400 may include a network interface 412 for connecting to a network. Other known electronic components may be added or substituted in the computer system 400.

While the embodiments have been described with reference to examples, various modifications to the described embodiments may be made without departing from the scope of the claimed embodiments.

What is claimed is:

1. A database archiving model error detection and correction system comprising:
an error detection module, executed by a computer system, to detect a referential integrity error in a database archiving model, wherein at least one of a column in a foreign key and a corresponding unique key column to the foreign key column include an assigned data mask operation, the error detection module detecting the referential integrity error if:
a corresponding other column in a foreign key-unique key relationship does not have an identical assigned data mask operation, or
the assigned data mask operation will not result in a unique output value for a unique input value.

2. The system of claim 1, further comprising an error correction module to correct the referential integrity error by assigning a foreign key column assigned data mask operation to the unique key column, or by assigning a unique key column assigned data mask operation to the foreign key column.

3. The system of claim 1, wherein the corresponding other column in the foreign key-unique key relationship does not have the identical assigned data mask operation if masks used for assigned data mask operations for the column in the foreign key and the corresponding other column are not identical.

4. The system of claim 1, wherein the corresponding other column in the foreign key-unique key relationship does not have the identical assigned data mask operation if mask parameters used for assigned data mask operations for the column in the foreign key and the corresponding other column are not identical.

5. The system of claim 1, further comprising an error display module to allow a user to selectively correct the referential integrity error by assigning a foreign key column assigned data mask operation to the unique key column, or by assigning a unique key column assigned data mask operation to the foreign key column.

6. The system of claim 1, wherein the corresponding other column in the foreign key-unique key relationship does not have the identical assigned data mask operation if masks used for assigned data mask operations for a column in one key and a corresponding other column in another key are not identical.

7. A method for detecting a referential integrity error in a database archiving model, wherein at least one of a column in a foreign key and a corresponding unique key column to the foreign key column include an assigned data mask operation, the method comprising:
detecting, by a computer, the referential integrity error in the database archiving model if:
a corresponding other column in a foreign key-unique key relationship does not have an identical assigned data mask operation, or
the assigned data mask operation will not result in a unique output value for a unique input value.

8. The method of claim 7, further comprising correcting the referential integrity error by assigning a foreign key column assigned data mask operation to the unique key column, or by assigning a unique key column assigned data mask operation to the foreign key column.

9. The method of claim 7, wherein the corresponding other column in the foreign key-unique key relationship does not have the identical assigned data mask operation if masks used for assigned data mask operations for the column in the foreign key and the corresponding other column are not identical.

10. The method of claim 7, wherein the corresponding other column in the foreign key-unique key relationship does not have the identical assigned data mask operation if mask parameters used for assigned data mask operations for the column in the foreign key and the corresponding other column are not identical.

11. The method of claim 7, further comprising allowing a user to selectively correct the referential integrity error by assigning a foreign key column assigned data mask operation to the unique key column, or by assigning a unique key column assigned data mask operation to the foreign key column.

12. The method of claim 7, wherein the corresponding other column in the foreign key-unique key relationship does not have the identical assigned data mask operation if masks used for assigned data mask operations for a column in one key and a corresponding other column in another key are not identical.

13. The method of claim 7, further comprising detecting referential integrity errors in all tables in the database archiving model.

14. A non-transitory computer readable medium storing machine readable instructions, that when executed by a computer system, perform a method for detecting a referential integrity error in a database archiving model, wherein at least one of a column in a foreign key and a corresponding unique key column to the foreign key column include an assigned data mask operation, the method comprising:
detecting, by a computer, the referential integrity error in the database archiving model if:
a corresponding other column in a foreign key-unique key relationship does not have an identical assigned data mask operation, or
the assigned data mask operation will not result in a unique output value for a unique input value.

15. The computer readable medium of claim 14, further comprising correcting the referential integrity error by assigning a foreign key column assigned data mask operation to the unique key column, or by assigning a unique key column assigned data mask operation to the foreign key column.

16. The computer readable medium of claim 14, wherein the corresponding other column in the foreign key-unique key relationship does not have the identical assigned data mask operation if masks used for assigned data mask operations for the column in the foreign key and the corresponding other column are not identical.

17. The computer readable medium of claim 14, wherein the corresponding other column in the foreign key-unique key relationship does not have the identical assigned data mask operation if mask parameters used for assigned data mask operations for the column in the foreign key and the corresponding other column are not identical.

18. The computer readable medium of claim 14, further comprising allowing a user to selectively correct the referential integrity error by assigning a foreign key column assigned data mask operation to the unique key column, or by assigning a unique key column assigned data mask operation to the foreign key column.

19. The computer readable medium of claim 14, wherein the corresponding other column in the foreign key-unique key relationship does not have the identical assigned data mask operation if masks used for assigned data mask operations for a column in one key and a corresponding other column in another key are not identical.

20. The computer readable medium of claim 14, further comprising detecting referential integrity errors in all tables in the database archiving model.
